(19) United States
(12) Patent Application Publication
(10) Pub. No.: US 2015/0122945 A1
(43) Pub. Date: May 7, 2015

(54) PASSENGER AIRCRAFT WITH AUTOMATICALLY DEPLOYABLE AND/OR RETRACTABLE LANDING GEAR

(71) Applicant: Peter Apostolos Kavounas, Bellevue, WA (US)

(72) Inventor: Peter Apostolos Kavounas, Bellevue, WA (US)

(21) Appl. No.: 14/088,317

(22) Filed: Nov. 22, 2013

Related U.S. Application Data
(60) Provisional application No. 61/899,285, filed on Nov. 3, 2013.

(51) Int. Cl. B64C 25/30

(52) U.S. Cl. CPC B64C 25/30
USPC 244/102 R

(57) ABSTRACT

In embodiments, a passenger aircraft includes a body and a landing gear member that is retractable and deployable with respect to the body. The passenger aircraft also includes an altitude detection system. The landing gear member may become deployed automatically if a deploy condition related to the detected altitude is met, and/or retracted automatically if a retract condition related to the detected altitude is met. Accordingly, the action of deploying and/or retracting the landing gear becomes something that the pilot need only supervise, instead of doing. In addition, embodiments may become a helpful safety feature, in the event the pilot has become distracted.

### CROSS REFERENCE TO RELATED PATENT APPLICATIONS

This patent application claims priority from U.S. Provisional Patent Application Ser. No. 61/899,285, filed on Nov. 3, 2013, titled: “AIRCRAFT WITH AUTOMATICALLY DEPLOYABLE AND/OR RETRACTABLE LANDING GEAR”, the disclosure of which is hereby incorporated by reference for all purposes.

### BACKGROUND

Some passenger aircraft have landing gear that is deployable and retractable by the pilot. U.S. Pat. No. 5,745,053 teaches a landing gear warning apparatus and method for a pilot approaching a runway with retracted landing gear, so the pilot could deploy it.

### BRIEF SUMMARY

The present description gives instances of passenger aircraft and methods, the use of which may help overcome problems and limitations of the prior art.

In embodiments a passenger aircraft includes a body and a landing gear member that is retractable and deployable with respect to the body. The passenger aircraft also includes an altitude detection system. The landing gear member may become deployed automatically if a deploy condition related to the detected altitude is met, and/or retracted automatically if a retract condition related to the detected altitude is met.

An advantage over the prior art is that the action of deploying and or retracting the landing gear becomes something that the pilot need only supervise, instead of doing. In addition, embodiments may become a helpful safety feature, in the event the pilot has become distracted.

These and other features and advantages of this description will become more readily apparent from the following Detailed Description, which proceeds with reference to the drawings, in which:

### BRIEF DESCRIPTION OF THE DRAWINGS

FIG. 1A is a diagram of a passenger aircraft descending with its landing gear retracted, and in which a deploy condition has been just met, according to embodiments.

FIG. 1B is a diagram of the passenger aircraft of FIG. 1A, sometime after the time of FIG. 1A, and in which the landing gear has been deployed automatically according to embodiments.

FIG. 2 is a diagram of components of a passenger aircraft made according to embodiments.

FIG. 3 is a diagram of sample relative locations of altitude thresholds used to define the deploy condition while descending, according to embodiments.

FIG. 4 is a flowchart for illustrating methods according to embodiments.

FIG. 5A is a diagram of a passenger aircraft ascending with its landing gear deployed, and in which a retract condition has been just met, according to embodiments.

FIG. 5B is a diagram of the passenger aircraft of FIG. 5A, sometime after the time of FIG. 5A, and in which the landing gear members have been retracted automatically according to embodiments.

FIG. 6 is a diagram of sample altitude thresholds according to embodiments.

FIG. 7 is a flowchart for illustrating methods according to embodiments.

### DETAILED DESCRIPTION

As has been mentioned, the present description is about passenger aircraft and related methods. Embodiments are now described in more detail.

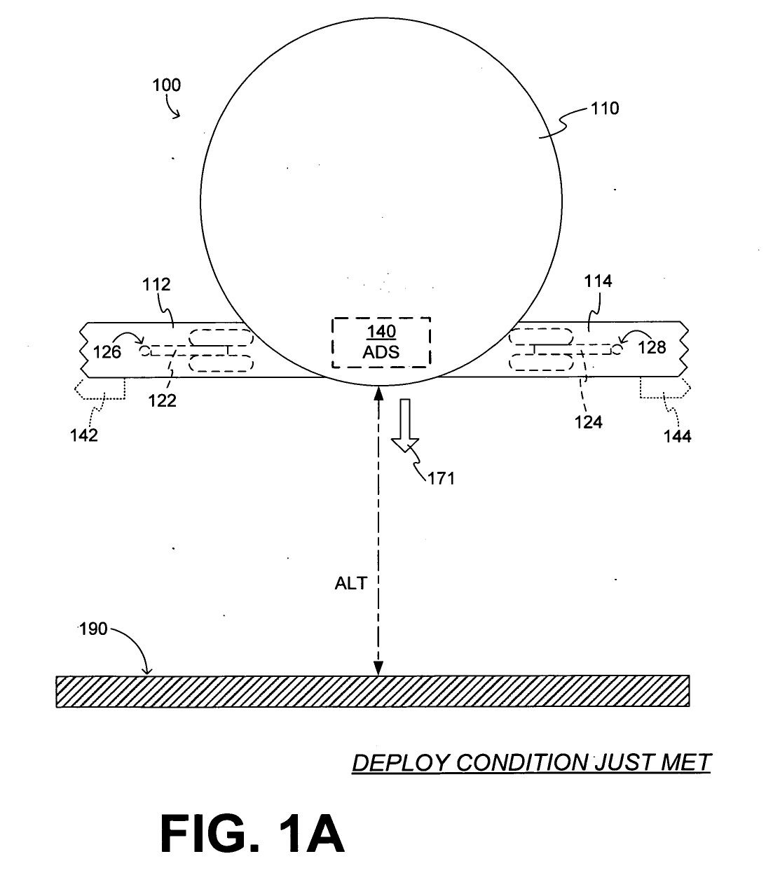

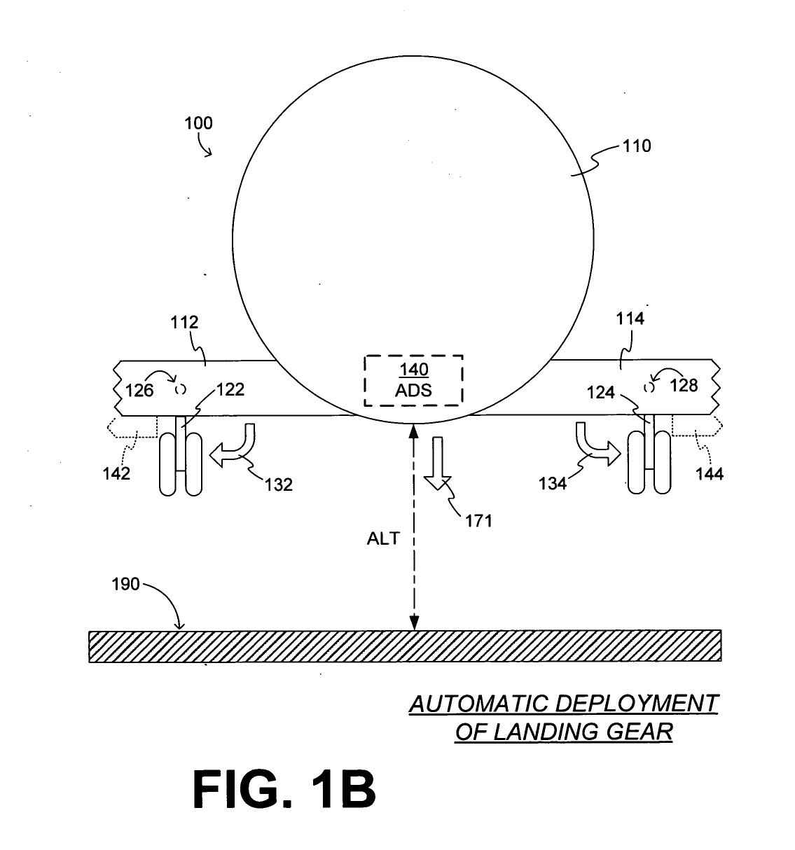

FIG. 1A is a diagram of a passenger aircraft 100, made according to sample embodiments. Aircraft 100 is flying above ground 190, and descending towards ground 190 according to descent arrow 171.

Passenger aircraft 100 has a body, which includes a fuselage 110. The passengers travel by being within fuselage 110. The body of aircraft 100 also includes wings 112, 114, and other components taken together. Wings 112, 114 include respective flaps 142, 144, which may be lowered so as to achieve the descent.

Aircraft 100 also includes landing gear. The landing gear includes members 122, 124, and also wheels for ground movement attached to landing gear members 122, 124. Landing gear member 122 is retractable and deployable with respect to the body, in this particular case by pivoting around a short axle 126 within wing 112. Axle 126 is on an axis perpendicular to the plane of the drawing. Similarly, landing gear member 124 is retractable and deployable, by pivoting around a short axle 128 within wing 114. Axle 128 can be parallel to axle 126. In the diagram of FIG. 1A, landing gear members 122, 124 are retracted.

Aircraft 100 further includes an altitude detection system (ADS) 140. ADS 140 is configured to detect an altitude ALT of the body relative to ground 190, and can be made in a number of ways. For example, it could employ components of a ground proximity warning system. Or it could include a barometer plus data about an elevation of a ground at the location the aircraft is at. Other ways include using directly a version of radar, and so on.

As shown in FIG. 1A, in passenger aircraft 100 a deploy condition has been just met, according to embodiments. The deploy condition relates to the detected altitude, and will be elaborated on below. Since the deploy condition is met, landing gear members 122, 124 may become deployed automatically. The deployment process may start at the instant of FIG. 1A, and continue as will be seen immediately below.

FIG. 1B is a diagram of the passenger aircraft of FIG. 1A, sometime after the time of FIG. 1A. Passenger aircraft has descended some more, compared to its altitude in FIG. 1A. It will be observed that landing gear members 122, 124 have been deployed. Deploying may have been performed automatically, according to embodiments. In this example, deploying has been performed by a motion of landing gear members 122, 124, around respective axles 126, 128 in the direction of respective arrows 132, 134.

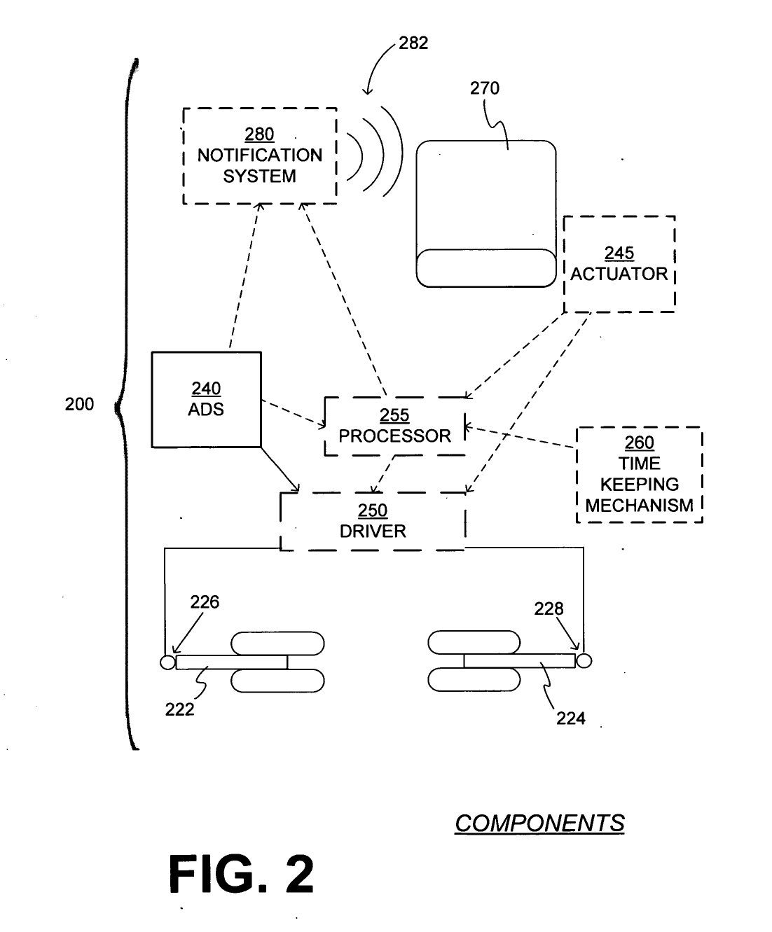

FIG. 2 is a diagram of components 200 of a passenger aircraft made according to embodiments. Any one of components 200 could be, for example, in aircraft 100 or aircraft 500 that is described later in this document.

Components 200 include an ADS 240, which can be made similarly as ADS 140. Components 200 also include landing gear components, such as landing gear members 222, 224 that support wheels and pivot around respective short axles 226, 228. Landing gear members 222, 224 could be made similarly to landing gear members 122, 124. Axles 226, 228 could be made similarly to axles 126, 128.

A driver 250 may be configured to deploy landing gear members 222, 224. Driver 250 may operate according to whether the deploy condition is met.

Components 200 optionally include in actuator 245, which would be operable by a person, such as a pilot. Actuator 245, if operated, it may override how driver 250 is controlled.

Components 200 also optionally include a processor 255. Processor 255 may be a computer, a microprocessor, an Application Specific Integrated Circuit (ASIC), and so on. Processor 255 can be configured to determine whether the deploy condition is met, and accordingly control driver 250 as to whether driver 250 would deploy landing gear members 222, 224. Determining can be performed from inputs received by ADS 240. If provided, actuator 245 may override the deploy condition by operating in the workings of processor 255, whether software, firmware or hardware.

Components 200 further optionally include a time-keeping mechanism 260. Time-keeping mechanism 260 can be configured to provide time inputs, and may be implemented within processor 255.

The deploy condition may be implicitly determined, or explicitly defined in software, such as by setting of a flag. Embodiments of how the deploy condition is defined are now described in more detail.

The deploy condition could include that the altitude is lower than a first threshold. In other embodiments, a rate of descent is combined with a time measurement, such as from the time inputs of time-keeping mechanism 260. So, the deploy condition could include that the altitude is lower than a second threshold, plus the detected altitude has decreased by a certain amount over a certain time interval measured from at least one of the time inputs. In some instances, the deploy condition could include that the flaps are down at least in part, as a safety precaution.

The various mentioned thresholds can be defined in terms of safety precautions, to prevent the aircraft from landing with the landing gear retracted. As such, expected inputs can be pilot response times, landing gear deployment times, rates of descent and other considerations, as will be obvious or evident to a person skilled in the art. Examples are now described.

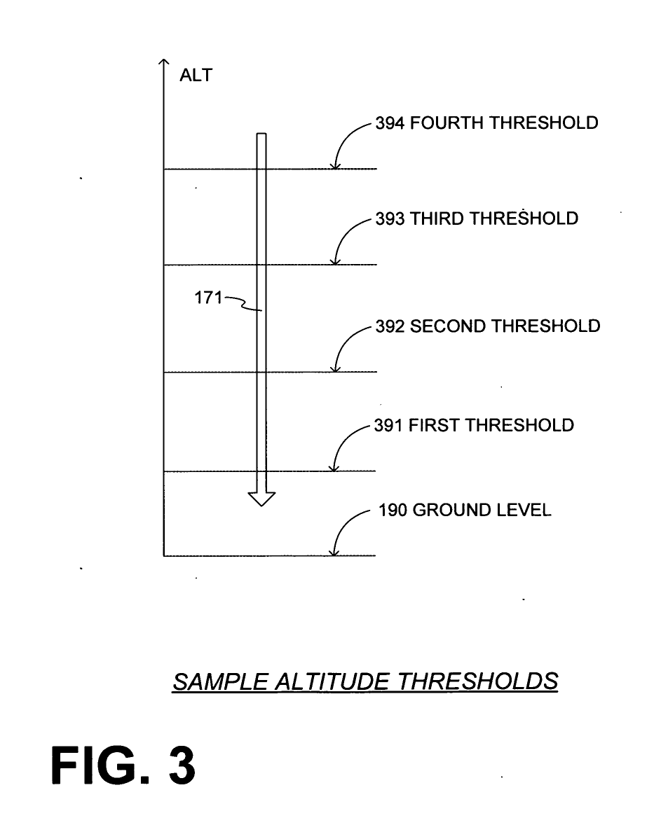

FIG. 3 is a diagram of sample altitude thresholds used to define the deploy condition, according to embodiments. The altitude thresholds are defined in terms of ground level 190, and while passenger aircraft 100 is descending. Descending is depicted in FIG. 3 by descent arrow 171. There is shown the first, the second, a third and a fourth threshold 391, 392, 393, 394. These altitude thresholds are not to scale. Rather, FIG. 3 shows sample locations for them, relative to each other.

Returning to FIG. 2, components 200 may also include a seat 270 intended for a pilot. Actuator 245 could he located so that a pilot seated in seat 270 can access actuator 245 and operate it. Components 200 could further include a notification system 280, which can be configured to issue a notification 282 to a pilot seated in seat 270. In some embodiments, notification 282 is a warning, if a warning condition is met related to the detected altitude.

Like with the deploy condition, the warning condition may be implemented in any number of ways. For example, the warning condition could include that the detected altitude is lower than a third threshold, such as third threshold 393. Or, a rate of descent can be combined with a time measurement such as from the time inputs of time-keeping mechanism 260. So, the warning condition could include that the detected altitude is lower than a fourth threshold plus the detected altitude has decreased by a certain amount over a certain time interval measured from at least one of the time inputs.

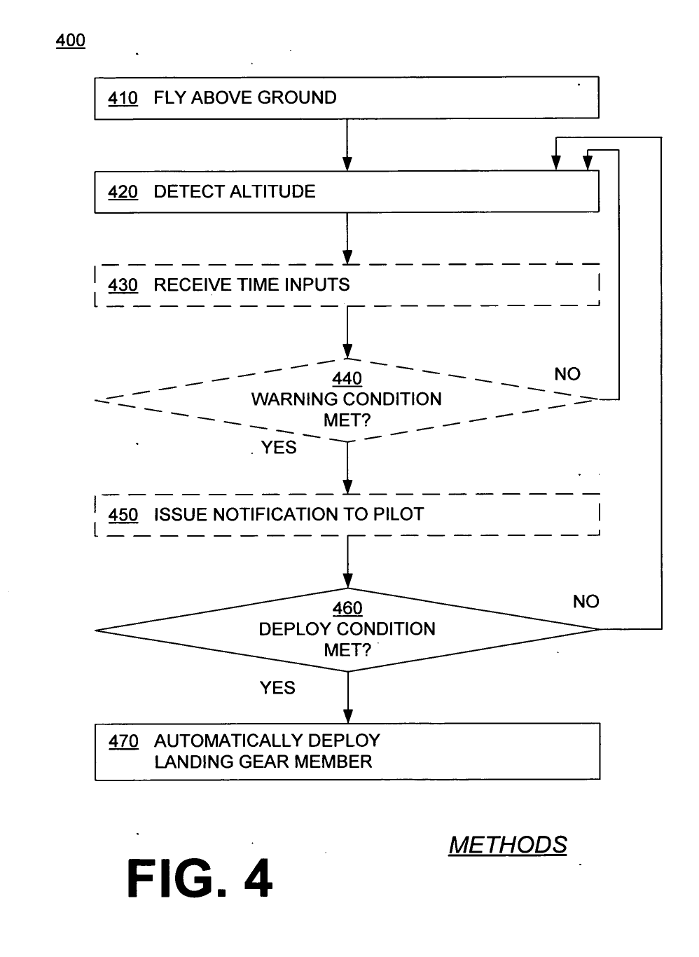

FIG. 4 shows a flowchart 400 for describing methods according to embodiments. The methods of flowchart 400 may also be practiced by embodiments described above, such as passenger aircraft 100.

According to an operation 410, a passenger aircraft flies above ground. Its landing gear member could be retracted with respect to its body. According to another operation 420, an altitude of the body relative to the ground may be detected. According to another, optional operation 430, time inputs are received.

According to another, optional operation 440, it is inquired whether a warning condition is met. The warning condition may be implemented as above. If not then execution can branch to another operation, such as return to operation 420. if yes, then according to another, optional operation 450, a notification is issued to a pilot. The notification can be a warning, for example that the landing gear needs to be deployed.

According to another operation 460, it is inquired whether a deploy condition is met. The deploy condition may be implemented as above. If not then execution can branch to another operation, such as return to operation 420. If yes, then according to another operation 470, the landing gear member can be deployed, even automatically.

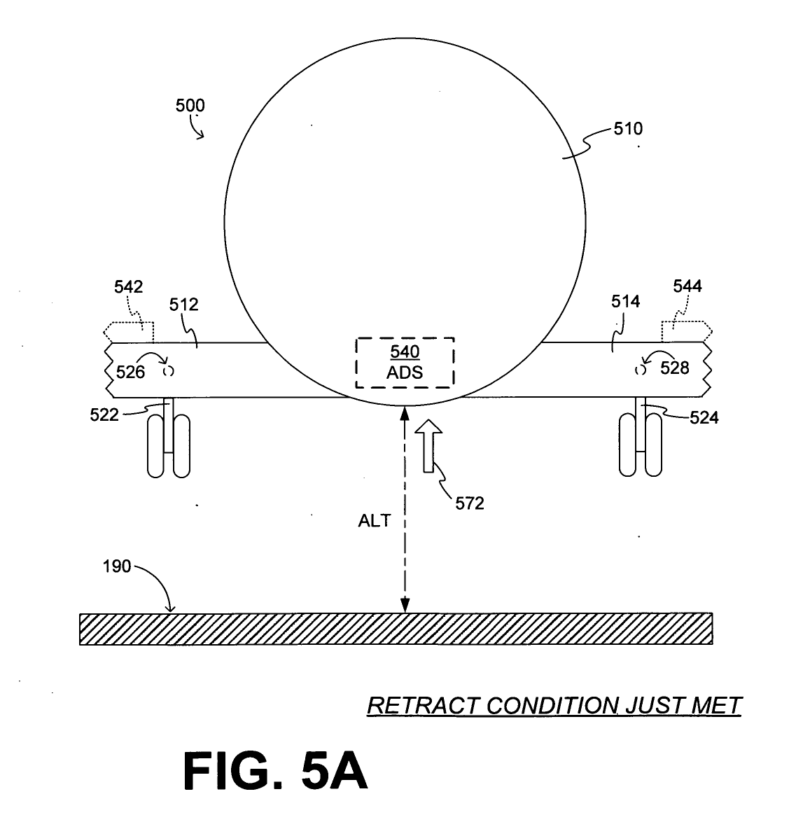

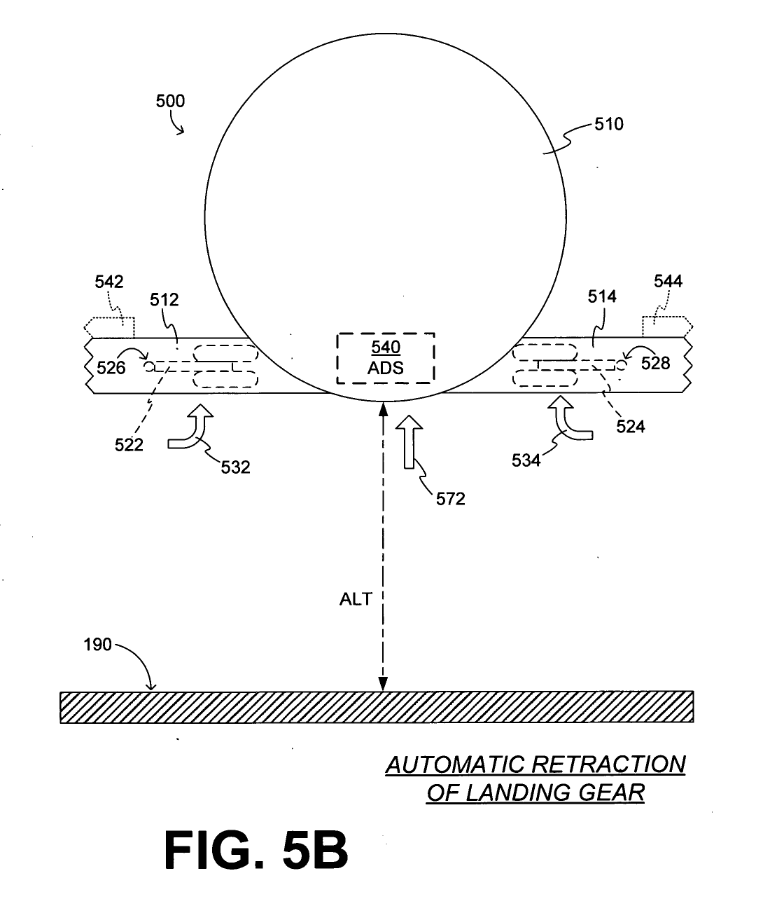

FIG. 5A is a diagram of a passenger aircraft 500, made according to sample embodiments. Aircraft 500 is flying above ground 190, and ascending from ground 190 according to ascent arrow 572.

As will be seen, many aspects of aircraft 500 could be similar to respective aspects of passenger aircraft 100. Passenger aircraft 500 has a body, which includes a fuselage 510. The passengers travel by being within fuselage 510. The body of aircraft 500 also includes wings 512, 514, and other components taken together. Wings 512, 514 include respective flaps 542, 544, which may be raised so as to achieve the ascent.

Aircraft 500 also includes landing gear. The landing gear includes members 522, 524, and also wheels for ground movement attached to landing gear members 522, 524. Landing gear member 522 is retractable and deployable with respect to the body, in this particular case by pivoting around a short axle 526 within wing 512. Axle 526 is on an axis perpendicular to the plane of the drawing. Similarly, landing gear member 524 is retractable and deployable, by pivoting around a short axle 528 within wing 514. Axle 528 can be parallel to axle 526. In the diagram of FIG. 5A, landing gear members 522, 524 are deployed.

Aircraft 500 further includes an altitude detection system (ADS) 540. ADS 540 is configured to detect an altitude ALT of the body relative to ground 190, and can be made in a number of ways, such as was described for ADS 140.

As shown in FIG. 5A, in passenger aircraft 500 a retract condition has been just met, according to embodiments. The retract condition relates to the detected altitude, and will be elaborated on below. Since the retract condition is met, landing gear members 522, 524 may become retracted automatically. The retracting process may start at the instant of FIG. 5A, and continue as will be seen immediately below.

FIG. 5B is a diagram of the passenger aircraft of FIG. 5A, sometime after the time of FIG. 5A. Passenger aircraft has ascended some more, compared to its altitude in FIG. 5A. It will be observed that landing gear members 532, 524 have been retracted. Retracting may have been performed automatically, according to embodiments. In this example, retracting has been performed by a motion of landing gear members 522 524, around respective axles 526, 528 in the direction of respective arrows 532, 534.

As mentioned above, FIG. 2 is a diagram of components 200 of a passenger aircraft made according to embodiments that could also be aircraft 500.

ADS 240 can be made similarly as ADS 540. Landing gear members 222, 224 could be made similarly to landing gear members 523, 524. Axles 226, 228 could be made similarly to axles 526, 528.

Driver 250 may be configured to retract landing gear members 222, 224, instead of, or in addition to deploying them as described above. Driver 250 may operate according to whether the retract condition is met. Actuator 245, if operated, it may override how driver 250 is controlled.

Processor 255 can be configured to determine whether the retract condition is met, and accordingly control driver 250 as to whether driver 250 would retract landing year members 222, 224. Again, determining can be performed from inputs received by ADS 240. If provided, actuator 245 may override the retract condition by operating in the workings of processor 255, whether software, firmware or hardware.

The retract condition may be implicitly determined, or explicitly defined in software, such as by setting of a flag. Embodiments of how the retract condition is defined are now described in more detail.

The retract condition could include that the altitude is higher than a fifth threshold. In other embodiments, a rate of ascent is combined with a time measurement, such as from the time inputs of time-keeping mechanism 260. So, the retract condition could include that the altitude is higher than a sixth threshold, plus the detected altitude has increased by a certain amount over a certain time interval measured from at least one of the time inputs. In some instances, the deploy condition could include that the flaps are up at least in part.

The various mentioned thresholds can be defined in terms of precautions related to the risk of flying with the landing gear deployed. The risk is increased drag from air resistance, but not as critical as the risk of the aircraft landing with the landing gear retracted, As such, expected inputs can be pilot response times, landing gear retraction times and other considerations, as will be obvious or evident to a person skilled in the art. Examples are now described.

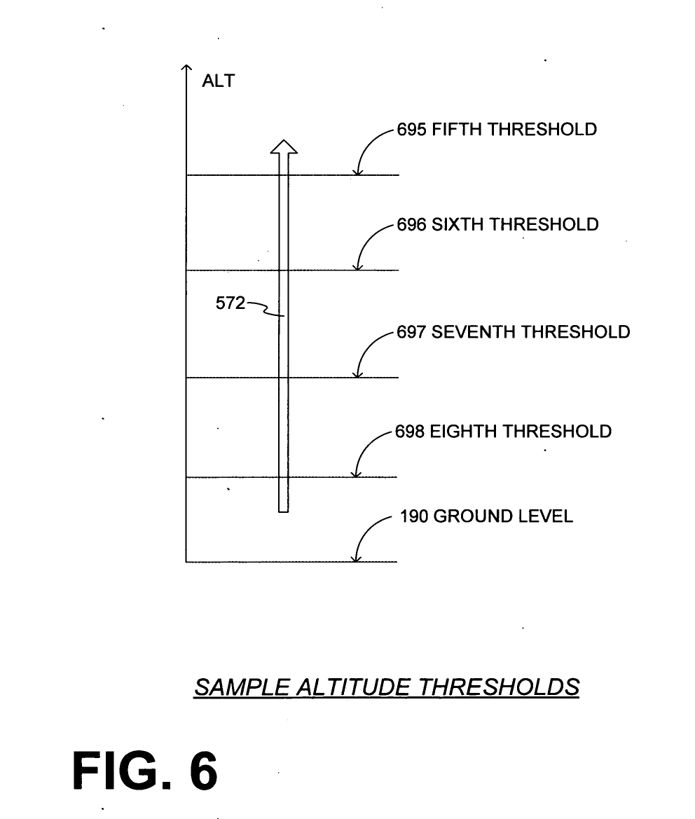

FIG. 6 is a diagram of sample altitude thresholds used to define the retract condition, according to embodiments. The altitude thresholds are defined in terms of ground level 190, and while passenger aircraft 500 is ascending. Ascending is depicted in FIG. 6 by ascent arrow 572. There is shown the fifth, the sixth, a seventh and an eighth threshold 695, 696, 697, 698. These altitude thresholds are not to scale. Rather, FIG. 6 shows sample locations for them, relative to each other.

Returning to FIG. 2, notification 282 can be a reminder, if a reminder condition is met related to the detected altitude. Like with the retract condition, the reminder condition may be implemented in any number of ways. For example, the reminder condition could include that e detected altitude is higher than a seventh threshold, such as seventh threshold 697. Or, a rate of ascent can be combined with a time measurement, such as from the time inputs of time-keeping mechanism 260. So, the reminder condition could include that the detected altitude is higher than an eighth threshold plus the detected altitude has increased by a certain amount over a certain time interval measured from at least one of the time inputs.

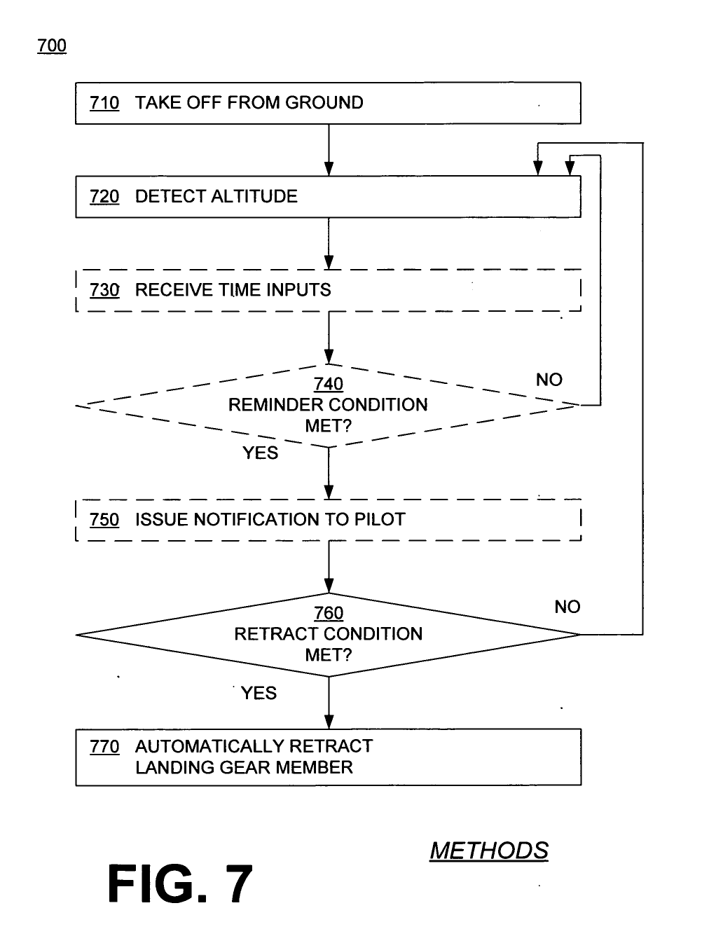

FIG. 7 shows a flowchart 700 for describing methods according to embodiments. The methods of flowchart 700 may also be practiced by embodiments described above, such as passenger aircraft 500.

According to an operation 710, a passenger aircraft takes off from ground. Its landing gear member could be deployed with respect to its body. According to another operation 720, an altitude of the body relative to the ground may he detected. According to another, optional operation 730, time inputs are received.

According to another, optional operation 740, it is inquired whether a reminder condition is met. The reminder condition may be implemented as above. If not, then execution can branch to another operation, such as return to operation 720. If yes, then according to another, optional operation 750, a notification is issued to a pilot. The notification can be a reminder, for example that the landing gear needs to be retracted.

According to another operation 760, it is inquired whether a retract condition is met. The retract condition may be implemented as above. If not, then execution can branch to another operation, such as return to operation 720. If yes, then according to another operation 770, the landing gear member can be retracted, even automatically.

In the methods described above, each operation can be performed as an affirmative step of doing, or causing to happen, what is written that can take place. Such doing or causing to happen can be by the whole system or device, or just one or more components of it. In addition, the order of operations is not constrained to what is shown, and different orders may be possible according to different embodiments. Moreover, in certain embodiments, new operations may be added, or individual operations may be modified or deleted. The added operations can be, for example, from what is mentioned while primarily describing a different system, device or method.

This description includes one or more examples, but that does not limit how the invention may be practiced. Indeed, examples or embodiments of the invention may be practiced according to what is described, or yet differently, and also in conjunction with other present or future technologies.

A person skilled in the art will be able to practice the present invention in view of this description, which is to be taken as a whole. Details have been included to provide a thorough understanding. In other instances, well-known aspects have not been described, in order to not obscure unnecessarily the present invention.

Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the advantages of the features incorporated in such combinations and sub-combinations.

The following claims define certain combinations and subcombinations of elements, features and steps or operations, which are regarded as novel and non-obvious. Additional claims for other such combinations and subcombinations may be presented in this or a related document.

1. An aircraft configured to fly above ground, comprising:
a body;
a processor;
a time-keeping mechanism configured to provide time inputs, the time keeping mechanism implemented within the processor;
a landing gear member that is retractable and deployable with respect to the body;
a driver; and
an altitude detection system configured to detect an altitude of the body relative to the ground, and
in which the landing gear member becomes deployed automatically if a deploy condition related to the detected altitude is met,
the deploy condition is that the detected altitude has decreased by a certain amount over a certain time interval measured from at least one of the time inputs,
the processor is configured to determine whether the deploy condition is met, and
the driver is configured to deploy, as controlled by the processor, the landing gear member if the deploy condition is met.

2-34. (canceled)
